(19) United States
(12) Patent Application Publication
(10) Pub. No.: US 2004/0258266 A1
(43) Pub. Date: Dec. 23, 2004

(54) Microphone

(76) Inventor: Raimund Staat, Burgwedel (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/821,905

(22) Filed: Apr. 9, 2004

(30) Foreign Application Priority Data
Apr. 14, 2003 (DE) 103 17 264.5

(51) Int. Cl. H04R 1/20; H04R 19/04; H04R 17/02; H04R 1/02

(52) U.S. Cl. 381/353; 381/369; 381/355; 381/375

(57) ABSTRACT

The invention relates to a microphone, in particular a microphone which is used in microphone headsets (also called boomsets). The object of the present invention is to create a microphone headset which firstly has an unobtrusive lens system, has a small size and with which only few popping sounds are picked up, therefore in which great wind noise insensitivity is provided, which moreover does not have a projecting, bent arm and moreover is also aligned optimally with the user's mouth. A microphone having a diaphragm system, wherein the microphone comprises the first sound inlet in a first opening and the second sound inlet in a second opening, and wherein the sound inlet strikes against the diaphragm largely uninfluenced via the first opening, whereas with the second sound inlet an acoustic damping element is constructed, with which the sound is damped at the second sound inlet, wherein the first sound inlet lies with the long microphone center axis behind the diaphragm and the second sound inlet thus lies on the microphone center axis in front of the diaphragm.

### CROSS-REFERENCE TO RELATED APPLICATION

This application claims priority of German Application No. 103 17 264.5, filed Apr. 14, 2003, the complete disclosure of which is hereby incorporated by reference.

### BACKGROUND OF THE INVENTION

a) Field of the Invention

The invention relates to a microphone, in particular a microphone which is used in microphone headsets (also called boomsets).

b) Description of the Related Art

Such microphone headsets have been known for a long time and are used in many different situations and places, e.g. during musical performances, in call centers, in aircraft and vehicle cockpits, etc. The known microphone headsets always comprise a microphone capsule, e.g. of type ME 105 from Sennheiser or P6 from Countryman. The microphone capsules are usually cylindrical capsules or flat capsules, which are mounted on an arm of the headsets so that the microphones can be aligned with the user's mouth in the desired manner.

One disadvantage is that, on account of the size, the capsules can not always be optimally aligned at the desired angle, above all, however, the microphone capsule cannot be optimally aligned to suppress the wind noise.

The wind noise is the sound which does not come from the user himself from talking and singing, but which comes from outside, for example also from a monitor loudspeaker on the stage or also from breathing sounds—so-called popping noises—from the user. The latter can be effectively suppressed by installing an anti-popping device.

The microphones previously used a microphone headsets are always a housing with a front sound inlet, by which the sound is picked up which comes from the user of the headset, and a rear sound inlet with which a directional characteristic is imparted to the microphone, such as e.g. cardioid, supercardioid, supereight, etc.

The front sound inlet in this case always lies directly in front of the diaphragm and acoustically it is not damped or is scarcely damped, while the rear sound inlet is provided in various ways with a damping depending on what directional characteristic the microphone is intended to have.

### OBJECT AND SUMMARY OF THE INVENTION

The primary object of the present invention is to create a microphone headset which firstly has an unobtrusive appearance, a small size and with which only a few popping noises are picked up, in which therefore great wind noise insensitivity is provided, which furthermore does not have a projecting, bent arm and furthermore is aligned optimally with the user's mouth.

A microphone comprises a diaphragm system with a first diaphragm. The first diaphragm has a first and second surface. The microphone has a first sound inlet in a first opening and a second sound inlet in a second opening. The first sound inlet strikes the second surface of the diaphragm very largely unaffected by the first opening. An acoustic damping element is constructed at the second sound inlet for damping the sound of the second sound inlet before the sound strikes the first surface of the diaphragm. The first sound inlet is disposed behind the diaphragm in a main sound direction and the second inlet is disposed in front of the diaphragm in the main sound direction.

The achievement in accordance with the invention is firstly remarkably simple, secondly it is inconsistent with the previous structure of microphones. In accordance with the present invention, the front sound inlet is designed functionally as the rear sound inlet and the previous rear sound inlet is designed functionally as the front sound inlet.

The microphone in accordance with the invention comprises apertures in the housing wall, which lie along the center axis of the microphone behind the diaphragm, whereas the front sound inlet is provided with damping means so that this sound inlet functionally forms the rear sound inlet.

By the previous microphone principle of the front and rear sound inlets being exchanged, it is possible to achieve the object of the invention satisfactorily with respect to quality and simply.

The invention is explained in further detail below by means of various exemplified embodiments.

### BRIEF DESCRIPTION OF THE DRAWINGS

In the drawings:

FIG. 1 shows a representation of an already known microphone headset having a microphone capsule with supercardioid characteristic;

FIG. 2 shows a representation of another known microphone headset with a microphone capsule with transverse mouthpiece;

FIG. 3 shows a representation of a microphone headset in accordance with the invention;

FIG. 4 shows a representation of a microphone headset in accordance with another exemplified embodiment of the invention;

FIGS. 5a to 5e show known microphone headsets;

FIG. 5f shows a representation of a microphone headset in accordance with the invention;

FIG. 6 shows a cross section through a microphone according to the invention;

FIG. 7 shows a cross section through another microphone according to the invention;

FIG. 8 shows a cross section through another microphone according to the invention; and

FIG. 9 shows a frequency response of a microphone according to the invention.

### DESCRIPTION OF THE PREFERRED EMBODIMENTS

FIG. 1 shows in principle a representation of an already known microphone headset (boomset) MH having a microphone capsule MC with supercardioid characteristics. The microphone with axial mouthpiece (axial also relates to the arm axis of the headset) has a front sound inlet FSI on the end face of a normally cylindrical microphone housing, on the surface of which the rear sound inlets RSI are located. By forming damping elements at the rear sound inlets RSI, the directional characteristic can be adjusted. Such a microphone on a microphone headset (boomset) MH would unfortunately not suppress the wind noise WN coming from the front, for example the sound of the monitor boxes on a stage, but would optimally pick it up.

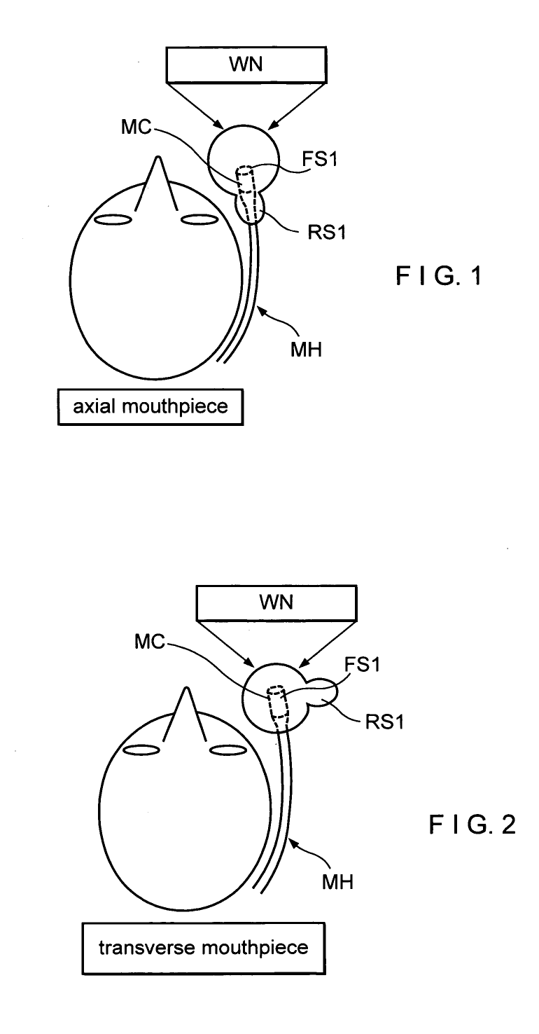

FIG. 2 shows a configuration similar to FIG. 1, with which, however, a microphone with transverse mouthpiece is used, i.e. a microphone which in its front sound inlet FSI is aligned with the user's mouth, so that the rear sound inlet RSI is directed away from the user's mouth. The development of the microphone with axial mouthpiece by 90° brings this improvement. However it would be visually more attractive and unobtrusive if the microphone had a transverse mouthpiece.

Microphones with transverse mouthpiece are distinguished by the fact that the opposite front and rear sound inlets FSI, RSI are disposed on the most extensive housing surface. In the example shown in FIG. 2, sound inlets are situated on the left on the surface of an oblong, cylindrical microphone housing.

In common designs such as the microphone P6 from Countryman, the microphone has to also be quite large and have a rectangular design.

Such a microphone, as shown in FIG. 2, on a straight arm does not optimally suppress the wind noise coming from the front. For this purpose, the microphone would have to be rotated by 90° in the anticlockwise direction and the arm should be strongly angled at the front so that the front sound inlet FSI of the microphone lies directly in front of the user's mouth.

An optimal alignment of the microphone with transverse mouthpiece is, however, frequently dispensed with, since this results either in positions very close to the mouth or in greatly projecting, swung arm, which are rejected for visual reasons.

The position directly in front of the mouth is particularly critical, because the air flow from the mouth and nose there, which are scarcely audible, are perceived as particularly annoying popping sounds.

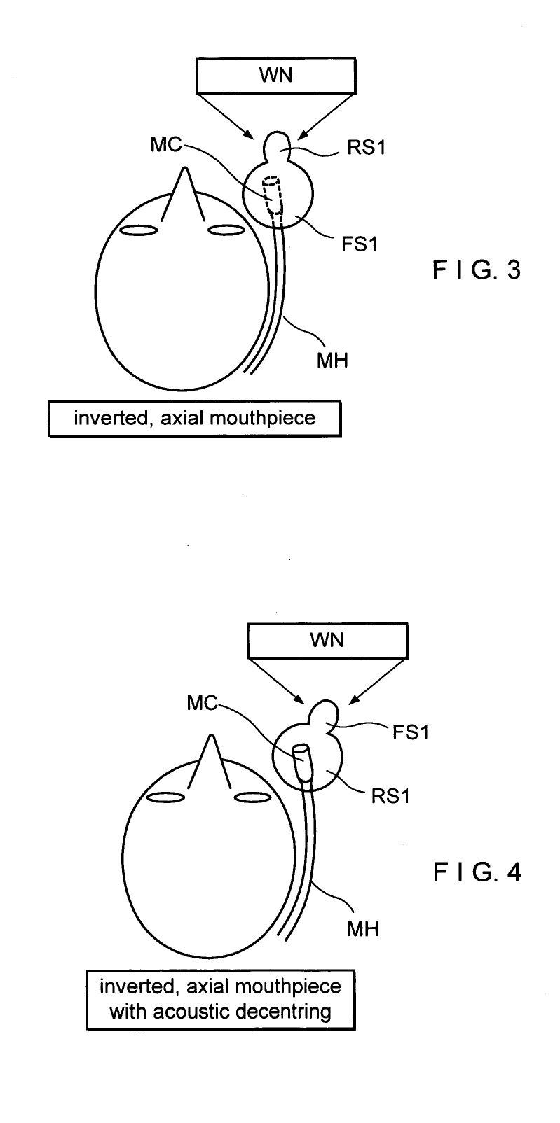

FIG. 3 shows an example according to the invention with an inverted, axial mouthpiece.

In FIG. 3 it can be seen that a microphone with axial mouthpiece has a supercardioid characteristic, with the alignment of the supercardioid being inverted exactly in comparison with the microphone shown in FIG. 1. Thus the sound from the monitor boxes can be efficiently suppressed.

Of course, other characteristics such as cardioid or eight or the like is possible, and are also customary for specific applications.

In the represented microphone headset MH, the proposed microphone MC can be aligned with inverted, axial mouthpiece with respect to the wind noise and at the same time the disturbing so-called popping effect can be reduced.

The shown microphone MC is a microphone having axial mouthpiece, in which the front and rear sound inlets FSI, RSI are transposed with respect to their function and mode of operation in comparison with constant microphones with axial mouthpieces.

Several proposals are represented below stating how these transpositions can be performed and how the generally customary cylindrical microphones can be modified.

The directional effect of directional microphones generally decreases drastically during a short-range conversation. The full directional effect of the microphone is only produced with more distant switching sources. Thus the exact alignment in relation to the sources of interference is particularly critical. Therefore, as in the microphone of the invention, the rear sound inlet RSE should always point forwards, so that it can suppress sound sources situated in this direction in the best possible manner.

FIG. 4 shows an optimal alignment for wind noise from the front using the example of a supercardioid which is preferably used on the stage to effectively mask out the monitor boxes. Other directional characteristics, such as cardioid, are also possible and specific applications are customary. They are generally aligned in the exactly the same way as the supercardioid.

With the more precise alignment to the mouth, the level and the sound can be slightly influenced. The distance to the mouth and to the nose and also strict observance of the chosen position during use is certainly more crucial.

This is due less to the directional effect of the microphone, which, as already described above, is anyway low for short-range conversation, but rather to the directed sound projection through mouth and nose.

An additional alignment of the microphone—see FIG. 4—to the mouth may be desirable for other reasons, if e.g. loud direct sound is to be masked from the rear. For this case, the screening of high frequencies by the head can be used.

If a mechanical alignment is to be avoided, this may also occur by an acoustic decentring. In the simplest case, this should be achieved by an asymmetrical arrangement of the sound inlets.

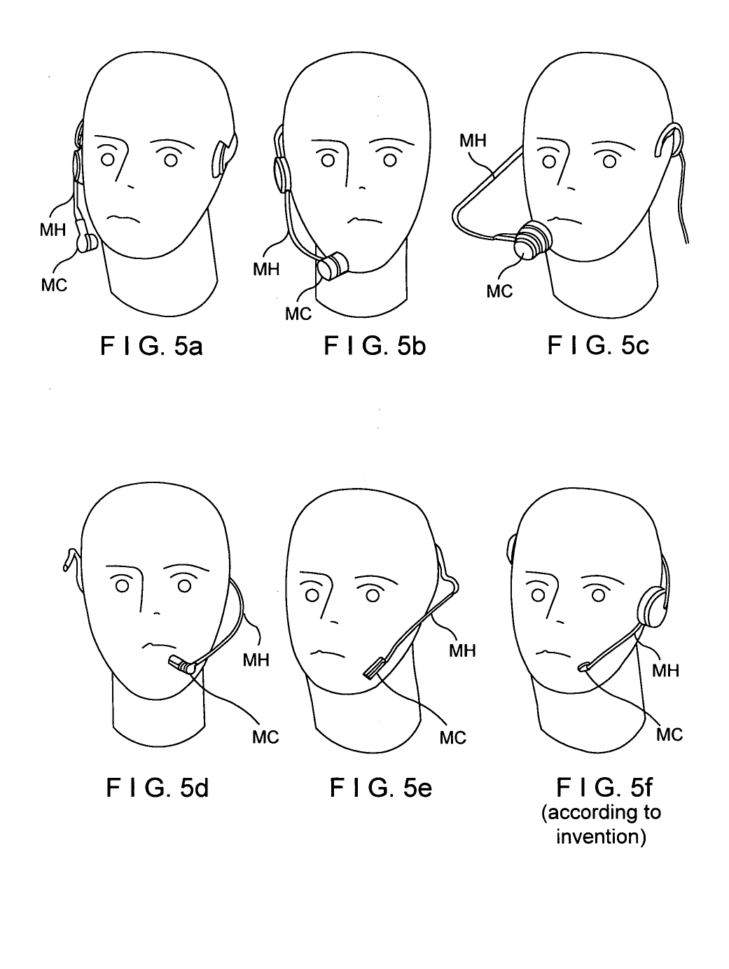

FIGS. 5a-e show known microphone headsets.

FIG. 5a shows the microphone headset C 444 from AKG, cardioid bent; lateral position to avoid popping sounds. The wind noise is suppressed on the right and mixed in on the left in the line of vision.

FIG. 5b shows the angled type ME 3 microphone headset from Sennheiser, supercardioid. The microphone capsule MC is laterally positioned to avoid popping noises.

FIG. 5c shows type CM 311 microphone headset from Crown, cardioid, arm with large curve. The microphone is optimally aligned from the front to suppress the wind noise, but an oversized anti-popping device is indispensable.

FIG. 5d shows the microphone headset ME 105 boomset from Sennheiser, supercardioid. The microphone is positioned laterally on the arm in order to avoid popping noises, but is frequently not optimally aligned.

FIG. 5e shows the angled microphone headset P6 from Countryman, supercardioid or cardioid with so-called transverse mouthpiece. The microphone is laterally positioned to avoid popping sounds. With the cardioid the wind noise is masked on the left and mixed in on the right in the line of vision.

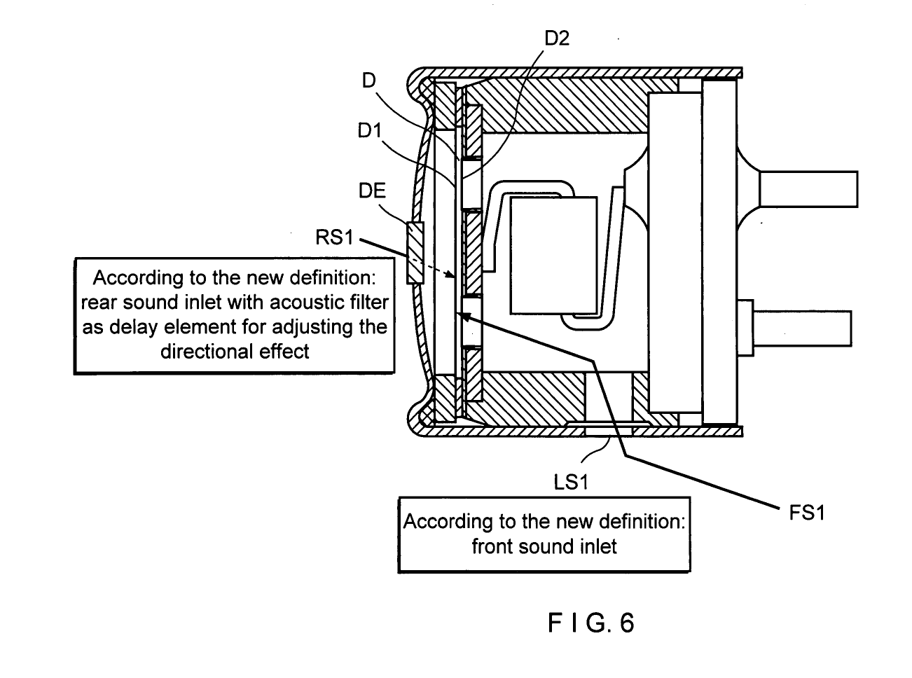

FIG. 6, and also FIG. 5f, show a microphone headset according to the invention, supercardioid or cardioid, the lateral position minimises popping sounds, the rear sound inlet points in the line of vision in order to suppress the wind noise from the front. FIG. 6 shows a cross section through a microphone according to the invention, which can be mounted on a headset in the previously known manner. In this case it can be seen that the microphone comprises a transducer system, the transducer being coupled with a diaphragm. The entire microphone is mounted in a housing, which at its front ends has a front sound inlet and at the side wall has another sound inlet.

The front sound inlet is provided with a damping element DE, which is mounted directly in the sound inlet itself or on a housing opening, so that the sound enters on the front side of the microphone and is transmitted to the diaphragm D in a damped state.

The sound inlet provided at the lateral housing wall allows the passage of entering sound to the diaphragm D, very largely unimpeded. By the described structure, the front sound inlet functionally becomes a rear sound inlet with acoustic filter as a delay element for adjusting the directional effect, while the lateral sound inlet LSI becomes a front sound inlet FSI with which the main sound is transmitted to the diaphragm D.

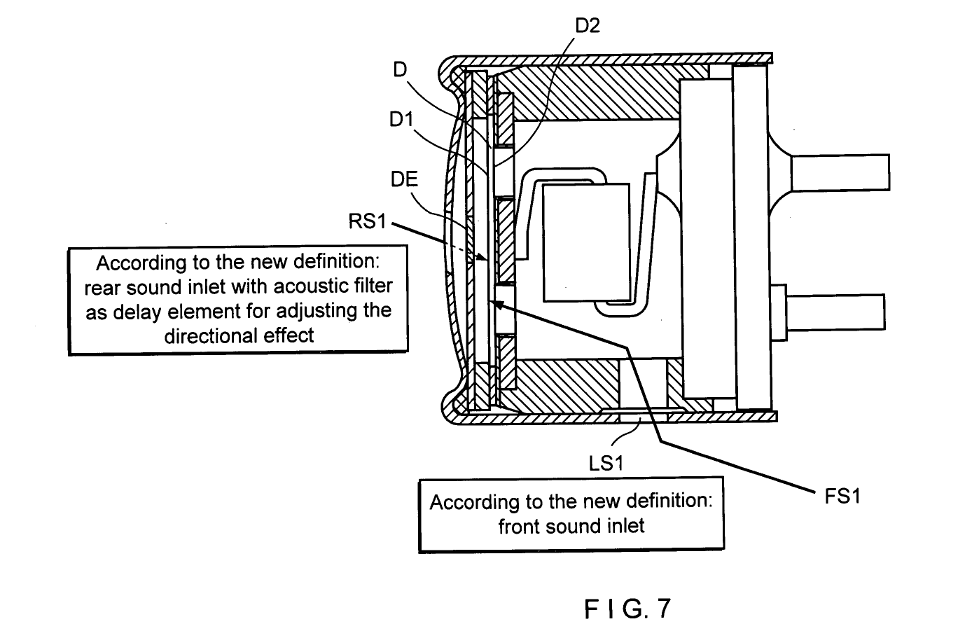

FIG. 7 shows a microphone similar to FIG. 6, in which a disk, which lies in front of the diaphragm ring D, forms an acoustic damping element DE, which accordingly damps sound that enters at the front side of the microphone, while the sound entering through the lateral housing opening LSI strikes the diaphragm D from the rear very largely undamped.

Instead of an air-permeable disk, as in the shown example, other disk-type acoustic damping elements may also be used.

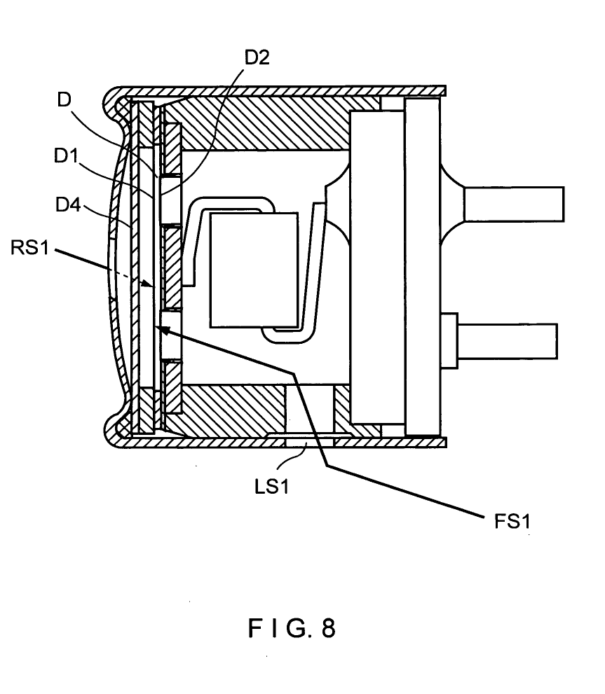

FIG. 8 shows an arrangement similar to FIG. 7, in which a second diaphragm D2 is disposed in front of the microphone diaphragm D, which is, however, purely passive and which is clearly more rigid than the microphone diaphragm D. The passive diaphragm D2 is perforated and thus acts as a damping element, whereas the electrically active diaphragm D is particularly flexible.

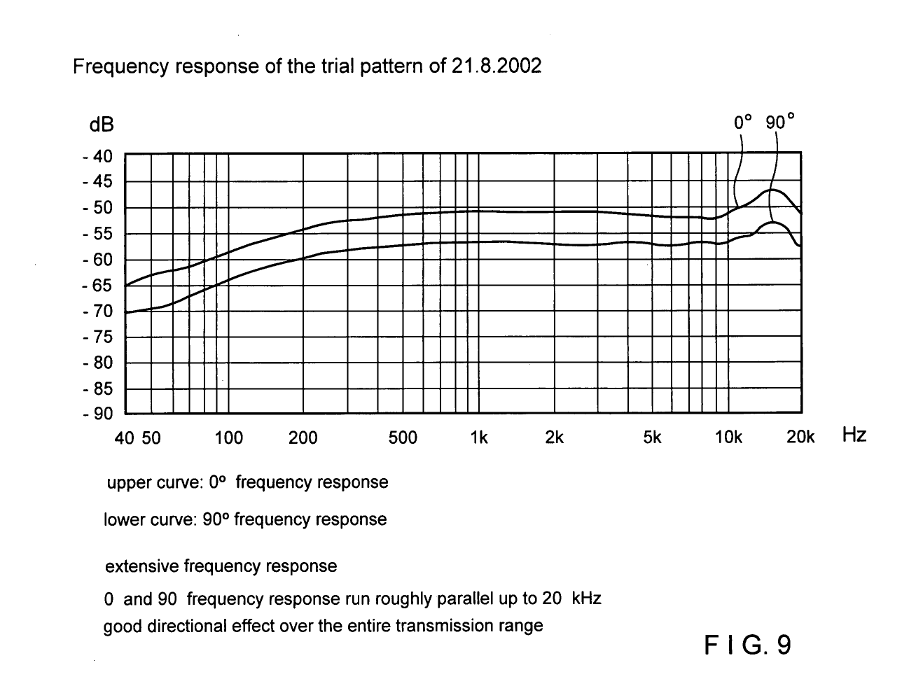

FIG. 9 shows the frequency response of a trial pattern of the microphone according to the invention. In this case the upper curve shows the 0° frequency response and the lower curve shows the 90° frequency response.

As shown, there is an extensive frequency response and the 0° and the 90° frequency response run roughly parallel up to 20 kHz, and there is a good directional effect over the entire transmission range.

As shown in FIGS. 6-9, a cylindrical capsule based on capsule KE 4 from Sennheiser may be used as the microphone capsule. The known KE 4 microphone capsules contain a front damped opening at the housing surface and a rear sound inlet, which is damped by specific means.

The second sound inlet is constructed with an acoustic damping element, which together with the volume formed between the damping element and the diaphragm forms an acoustic lowpass. The cut-off frequency of this acoustic lowpass corresponds to the travel time from the first to the second sound inlet. Alternatively to this, the cut-off frequency may correspond with the distance between the first and the second sound inlets.

The directional characteristic of the microphone can be adjusted with the ratio from the basic frequency and the distance or the travel time of the acoustic lowpass and the travel time of the sound from the first to the second sound inlet. This ratio is=1 for a “cardioid” directional characteristic, if a delay by further cavities inside the microphone capsule is disregarded.

While the foregoing description and drawings represent the present invention, it will be obvious to those skilled in the art that various changes may be made therein without departing from the true spirit and scope of the present invention.

What is claimed is:

1. A microphone comprising:
a diaphragm system with a first diaphragm, said first diaphragm having a first and a second surface;
said microphone having a first sound inlet in a first opening and a second sound inlet in a second opening;
said first sound inlet striking the second surface of the diaphragm very largely unaffected via the first opening;
an acoustic damping element being constructed at the second sound inlet for damping the sound of the second sound inlet before the sound strikes the first surface of the diaphragm; and
said first sound inlet being disposed behind the diaphragm in a main sound direction and the second sound inlet being disposed in front of the diaphragm in the main sound direction.

2. A microphone according to claim 1, wherein the microphone comprises a housing into which an opening is laterally provided, which forms the front sound inlet.

3. The microphone according to claim 1, wherein the microphone comprises a housing which contains an opening which lies in the main direction of sound in front of the diaphragm and on or in which a damping element is formed.

4. The microphone according to claim 1, wherein a damping element is constructed in the diaphragm and in the second opening.

5. The microphone according to claim 1, wherein the second sound inlet is constructed with an acoustic damping element, which together with the volume formed between the damping element and the first diaphragm forms an acoustic lowpass, the cut-off frequency of which corresponds with the travel time from the first sound inlet to the second sound inlet.

6. The microphone according to claim 1, wherein the second sound inlet is constructed with an acoustic damping element, which together with the volume formed between the damping element and the diaphragm forms an acoustic lowpass, the cut-off frequency of which corresponds with the distance between the first and second sound inlets.

7. In a microphone headset, a microphone according to claim 1.
